(19) United States
(12) Patent Application Publication
(10) Pub. No.: US 2018/0298544 A1
(43) Pub. Date: Oct. 18, 2018

(54) High-Efficiency Washer-Dryer System

(71) Applicant: Greg O'Rourke, San Francisco, CA (US)

(72) Inventor: Greg O'Rourke, San Francisco, CA (US)

(21) Appl. No.: 15/488,986

(22) Filed: Apr. 17, 2017

(51) Int. Cl. D06F 39/04; H01M 8/00; H01M 8/0612; H01M 8/04014; D06F 33/02; D06F 37/30; D06F 39/00; D06F 25/00; D06F 39/08; D06F 39/02

(52) U.S. Cl. CPC D06F 39/045; H01M 2008/1293; H01M 8/006; H01M 8/0618; H01M 8/04014; D06F 33/02; D06F 37/304; D06F 39/008; D06F 25/00; D06F 39/087; D06F 39/02; D06F 39/005; H01M 2250/405; H01M 2250/10; H01M 8/004

(57) ABSTRACT

In one embodiment, a washer-dryer system includes a fuel cell unit configured to generate electrical power and steam, a motor configured to receive electrical power from the fuel cell unit, a heat exchanger configured to receive steam from the fuel cell unit and configured to generate heated air and heated water, a rotatable drum configured to receive at least one of the heated air and the heated water from the heat exchanger, and a drive shaft coupled to the motor and the rotatable drum. In one embodiment, the washer-dryer system further includes a control unit configured to control operation of the motor such that the motor causes the drive shaft and the rotatable drum to rotate at a predetermined rotational speed. In one embodiment, the fuel cell unit includes at least one solid oxide fuel cell.

### FIELD OF THE INVENTION

The invention relates generally to washer-dryer systems and more particularly to a high efficiency washer-dryer system including a fuel cell.

### BACKGROUND

Industrial or commercial washers and dryers used in facilities such as hotels, restaurants, and hospitals typically handle much larger loads than household models, in the range of about 60-160 pounds of fabric. Such large machines require large amounts of energy to heat water for wash cycles, to heat air for dry cycles, and to power the motor that drives the fabric-holding drum. Current high-efficiency industrial dual-mode washer-dryer systems are only about 30-40% energy efficient. Current industrial laundry machines also typically rely on traditional sources of electrical power such as coal, oil, and natural gas that produce emissions such as nitrogen oxide (NOx) that contribute to air pollution. Thus there is a need for a cleaner, more energy efficient washer-dryer system.

### SUMMARY

In one embodiment, a washer-dryer system includes a fuel cell unit configured to generate electrical power and steam, a motor configured to receive electrical power from the fuel cell unit, a heat exchanger configured to receive steam from the fuel cell unit and configured to generate heated air and heated water, a rotatable drum configured to receive at least one of the heated air and the heated water from the heat exchanger, and a drive shaft coupled to the motor and the rotatable drum. In one embodiment, the washer-dryer system further includes a control unit configured to control operation of the motor such that the motor causes the drive shaft and the rotatable drum to rotate at a predetermined rotational speed. In one embodiment, the fuel cell unit includes at least one solid oxide fuel cell.

In one embodiment, dual mode fabric treatment apparatus includes a fuel cell unit configured to generate electrical power and steam, a motor configured to receive electrical power from the fuel cell unit, a heat exchanger configured to receive steam from the fuel cell unit and configured to generate heated air and heated water, a rotatable drum configured to receive the heated air from the heat exchanger during a dry cycle and to receive the heated water from the heat exchanger during a wash cycle; and a drive shaft coupled to the motor and the rotatable drum. In one embodiment, the dual mode fabric treatment apparatus further includes a control unit configured to control operation of the motor such that the motor causes the drive shaft and the rotatable drum to rotate at a predetermined rotational speed. In one embodiment, the fuel cell unit includes at least one solid oxide fuel cell.

### BRIEF DESCRIPTION OF THE DRAWINGS

FIG. 1 is a diagram of the operating principle of a solid oxide fuel cell.

FIG. 2 is a diagram of one embodiment of a high-efficiency washer-dryer system according to the invention.

FIG. 3 is a diagram of one embodiment of a high-efficiency washer-dryer system according to the invention.

### DETAILED DESCRIPTION

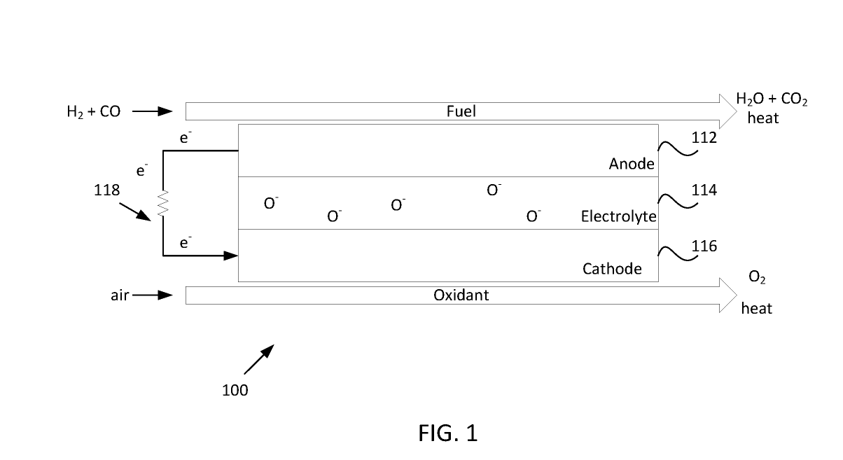

FIG. 1 is a diagram of the operating principle of a solid oxide fuel cell 100. A fuel cell converts a gaseous fuel to electrical energy and heat by electrochemically combining the fuel with an oxidant. Solid oxide fuel cell 100 includes an anode 112, an electrolyte 114, and a cathode 116. A fuel, such as hydrogen gas (H₂), natural gas methane (CH₃), and/or carbon monoxide (CO), is introduced to anode 112 and a oxidant, such as air containing oxygen, is introduced to cathode 116. Oxygen molecules supplied at cathode 116 react with incoming electrons from an external circuit 118 to form oxygen ions, which migrate to anode 112 through electrolyte 114, which is an ion-conducting ceramic material. At anode 112, oxide ions combine with hydrogen and/or CO in the fuel to form water (steam) and/or CO₂, freeing electrons. Electrons flow from anode 112 through external circuit 118 to cathode 116.

The electrochemical reactions within solid oxide fuel cell 100 generate a substantial amount of heat. For example, solid oxide fuel cell 100 can have an operating temperature in the range of about 650 to 1000° C. The generated heat causes water produced from fuel at cathode 112 to be output from solid oxide fuel cell 100 in the form of steam.

Solid oxide fuel cell designs include a tubular design and flat plate design. In a basic tubular design, the anode, electrolyte, and cathode material layers are formed into a tube. An oxidant flows through the center of the tube to contact the anode and a fuel flows over the outside of the tube to contact the cathode. In a basic flat plate design, the anode, electrolyte, and cathode materials are formed into layers of a rectangular plate. An oxidant flows over the anode side of the plate and a fuel flows over the cathode side of the plate. In a typical application, multiple fuel cells are connected together in series to form a stack (for planar cells) or a bundle (for tubular cells) because a stack or bundle generates a higher output voltage than an individual fuel cell.

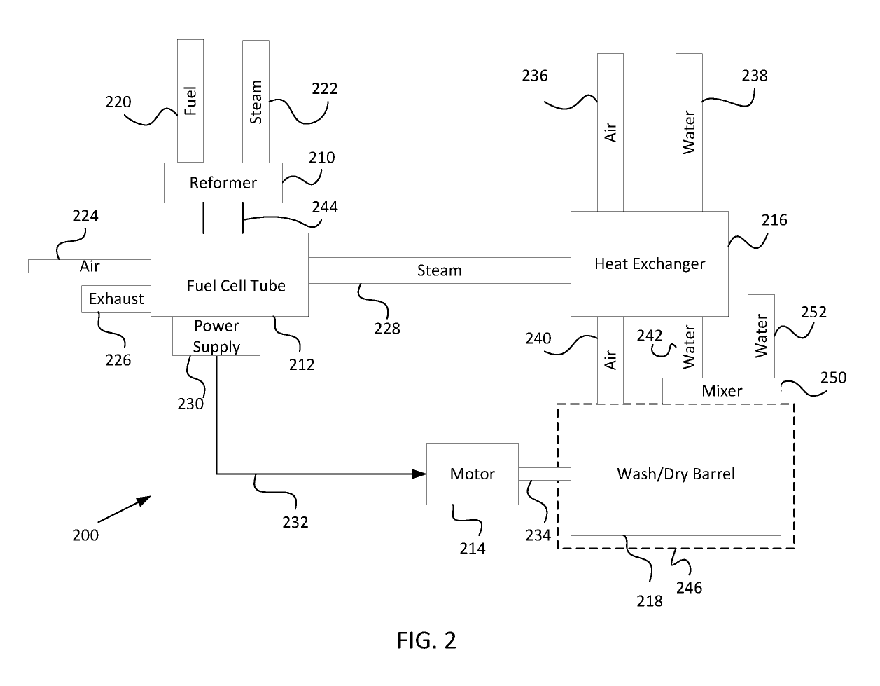

FIG. 2 is a diagram of one embodiment of a high-efficiency washer-dryer system 200 according to the invention. Washer-dryer system 200 has dual modes of operation to wash and dry fabric articles. The term “fabric article” used herein is intended to mean any article that is customarily cleaned in a conventional laundry process, including but not limited to articles of clothing, linen and drapery, clothing accessories, floor coverings, and furniture covers. Washer-dryer system 200 includes, but is not limited to, a reformer 210, a fuel cell tube 212, a power supply 230, a motor 214, a heat exchanger 216, and a wash/dry barrel 218. Reformer 210 receives a fuel, preferably a natural gas containing methane, from a fuel source 220 and steam from a steam source 222. In another embodiment, reformer 210 forms steam itself using an integrated heat source and water from a water source. Reformer 210 steam reforms the fuel to form hydrogen gas and carbon monoxide, which are output through a connector 244 to an anode (not shown) of fuel cell tube 212. In one embodiment, fuel cell tube 212 is a solid oxide fuel cell (SOFC) tube with a power rating of about 500 W. Fuel cell tube 212 receives air from an air source 224, and electrochemically reacts the fuel and air to produce electrical energy that is output to a power supply 230. Fuel cell tube 212 also produces steam that is output through a connector 228 to heat exchanger 216, and produces exhaust gases including carbon monoxide, carbon dioxide, and air that are output through an exhaust port 226. In another embodiment of washer-dryer system 200, fuel cell tube 212 self-reforms the fuel such that reformer 210 is not required.

Power supply 230 converts the electrical energy output from fuel cell tube 212 into an appropriate electrical signal that is output on a bus 232 to power motor 214. Motor 214 is coupled to a drive shaft 234 that drives rotation of wash/dry barrel 218. In one embodiment, motor 214 is a permanent magnet motor and is coupled to drive shaft 234 using a magnetic induction coupler. Any other type of motor capable of driving rotation of wash/dry barrel 218 is within the scope of the invention. Wash/dry barrel 218 is a perforated drum for rotating a load of fabric articles to be washed and dried and is located within an outer drum 246.

Heat exchanger 216 receives air from an air source 236 and water from a water source 238. Heat exchanger 216 heats the incoming air using steam received from fuel cell tube 212 and outputs the heated air through a connector 240 to wash/dry barrel 218 during a dry cycle. Heat exchanger 216 outputs water through a connector 242 to a mixer 250 at appropriate times during a wash cycle. Mixer 250 also receives unheated water from a water source 252. Depending on requirements of a particular wash cycle (e.g., a hot wash/cold rinse cycle), mixer 250 outputs water of the appropriate temperature to wash/dry barrel 218. For example, heat exchanger 216 heats water using steam received from fuel cell tube 212 to produce hot water that is output to mixer 250. If hot water is required, mixer 250 outputs hot water to wash/dry barrel 218. If warm water is required, mixer 250 mixes hot water from heat exchanger 216 and cold water from water source 252 and outputs warm water to wash/dry barrel 218. If cold water is required, mixer 250 outputs cold water from water source 252 directly to wash/dry barrel 218. In another embodiment, heat exchanger 216 itself performs the function of controlling the temperature of water output to wash/dry barrel 218.

Washer-dryer system 200 advantageously includes fuel cell tube 212 to provide both clean electricity to motor 214 and heat for wash and dry cycles of wash/dry barrel 218. Embodiments of washer-dryer system 200 can achieve energy efficiencies of about 60% or more. Although a fuel cell tube is shown in FIG. 2, other configurations of solid oxide fuel cells, including but not limited to a bundle of tubular SOFCs and a stack of planar SOFCs, are within the scope of the invention. Other types of fuel cells, for example proton exchange membrane or polymer exchange membrane (PEM) fuel cells are within the scope of the invention, but PEM fuel cells, which have operating temperatures around 200° C., may not provide the same level of energy efficiencies to washer-dryer system 200 as SOFCs.

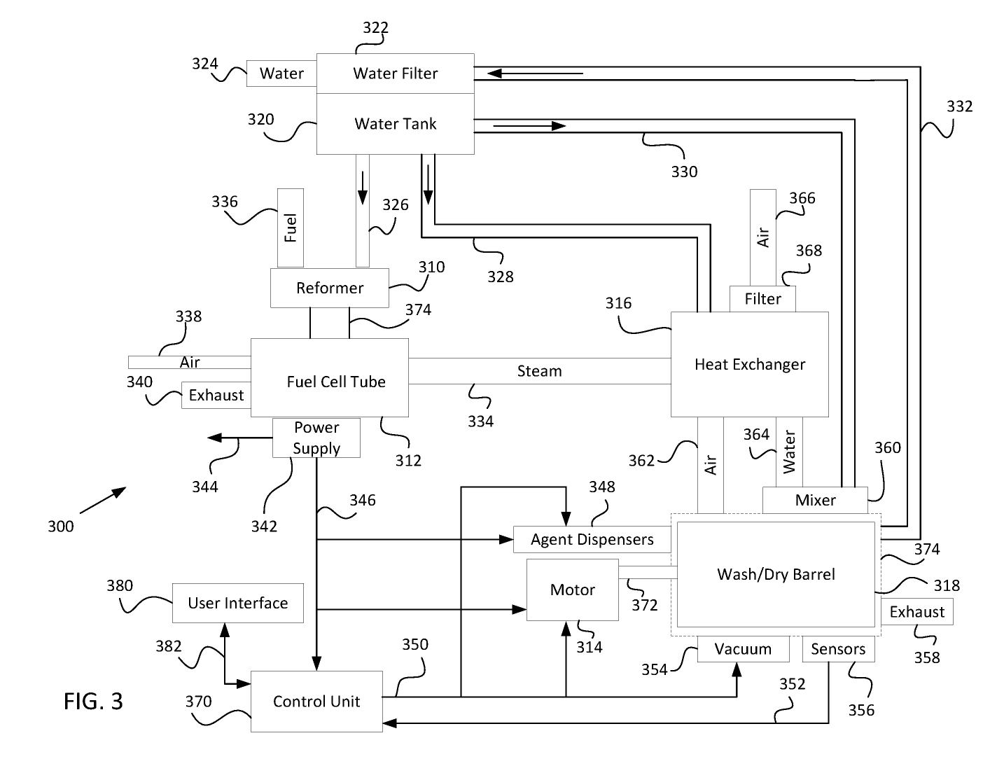

FIG. 3 is a diagram of one embodiment of a high-efficiency washer-dryer system 300 according to the invention. Washer-dryer system 300 has dual modes of operation to wash and dry fabric articles. Washer-dryer system 300 includes, but is not limited to, a reformer 310, a fuel cell tube 312, a power supply 342, a motor 314, a heat exchanger 316, a wash/dry barrel 318, a water tank 320 and water filter 322, and a control unit 370. Reformer 310 receives a fuel, preferably a natural gas containing methane, from a fuel source 336 and water through a connector 326 from water tank 320. Reformer 310 steam reforms the fuel to form hydrogen gas and carbon monoxide, which are output through a connector 374 to an anode (not shown) of fuel cell tube 312. In one embodiment, fuel cell tube 312 is a solid oxide fuel cell (SOFC) tube with a power rating of about 500 W. Fuel cell tube 312 receives air from an air source 338, and electrochemically reacts the fuel and air to produce electrical energy that is output to power supply 342. Fuel cell tube 312 also produces steam that is output through a connector 334 to heat exchanger 316, and produces exhaust gases such as carbon dioxide that are output through an exhaust port 340. In another embodiment of washer-dryer system 300, fuel cell tube 312 self-reforms the fuel such that reformer 310 is not required.

Power supply 342 converts the electrical energy output from fuel cell tube 312 into an appropriate electrical signal that is output on a bus 346 to power motor 314, control unit 370, and agent dispensers 348. When the electrical energy output from fuel cell tube 312 is not required for operation of motor 314 (e.g., when no wash or dry cycle is in progress), power supply 342 is configured to generate an electrical signal that can be output from washer-dryer system 300 through a connector 344. Electrical energy output from connector 344 can be used to power other systems (e.g., lighting, HVAC) located at the same premises as washer-dryer system 300 or can be input into the electrical power grid.

Motor 314 is coupled to a drive shaft 372 that drives rotation of wash/dry barrel 318. In one embodiment, motor 314 is a permanent magnet motor and is coupled to drive shaft 372 using a magnetic induction coupler. Any other type of motor capable of driving rotation of wash/dry barrel 318 is within the scope of the invention. Wash/dry barrel 318 is a perforated drum for rotating a load of fabric articles to be washed and dried and is located within an outer drum 374. An exhaust 358 allows for output of air from wash/dry barrel 318 during a dry cycle and a connector 332 allows for water to drain from wash/dry barrel 318 and outer drum 374 during a wash cycle. Connector 332 drains wash water to a water filter 322 coupled to water tank 320 to allow for reuse of the wash water. In another embodiment, wash water drained from wash/dry barrel 318 and outer drum 374 is discarded.

Heat exchanger 316 receives air through an air filter 368 from an air source 366 and receives water through a connector 328 from water tank 320. Heat exchanger 316 heats the incoming air using steam received from fuel cell tube 312 and outputs the heated air through a connector 362 to wash/dry barrel 318 during a dry cycle. Heat exchanger 316 outputs water through a connector 364 to a mixer 360 at appropriate times during a wash cycle. Mixer 360 also receives unheated water through a connector 330 from water tank 320. Depending on requirements of a particular wash cycle (e.g., a hot wash/cold rinse cycle or a warm wash/warm rinse cycle), mixer 360 outputs water of the appropriate temperature to wash/dry barrel 318. For example, heat exchanger 316 heats water using steam received from fuel cell tube 312 to produce hot water that is output to mixer 360. If hot water is required, mixer 360 outputs hot water to wash/dry barrel 318. If warm water is required, mixer 360 mixes hot water from heat exchanger 316 and cold water from water tank 320 and outputs warm water to wash/dry barrel 318. If cold water is required, mixer 360 outputs cold water from water tank 320 directly to wash/dry barrel 318.

Control unit 370 is a programmable device that includes but is not limited to a microprocessor that is configured to control the operation of motor 314, agent dispensers 348, and a vacuum 354. For example, in one embodiment control unit 370 is an embedded computing device such as a Raspberry Pi. Control unit 370 sends control signals to motor 314 over a bus 350 to start, stop, and control the speed of the rotation of wash/dry barrel 318. Control unit 370 sends control signals to agent dispensers 348 to control the dispensing of agents such as detergent, bleach, and fabric softener into wash/dry barrel 318 at appropriate times during a wash cycle. Control unit 370 sends control signals to vacuum 354 to control the air pressure within wash/dry barrel 318 during a dry cycle. Sensors 356 are coupled to wash/dry barrel 318 and provide information on water level, temperature, and air pressure to control unit 370 over a bus 352. Control unit 370 sends control signals to mixer 360 to control the output of hot, warm, or cold water to wash/dry barrel 318 as appropriate for the current state of a wash cycle. Control unit 370 also controls the input of air to wash/dry barrel 318 during a dry cycle and the draining of water from wash/dry barrel 318 during a wash cycle. A user interface 380 communicates with control unit 370 over a communications link 382. User interface 380 allows an operator to start and stop wash/dry cycles and to select particular wash/dry cycles (e.g., normal wash with hot water and bleach, high heat dry). User interface 380 also enables an operator to observe current status information for washer-dryer system 300 and other information such as the total number of wash/dry cycles and energy usage. In one embodiment, user interface 380 is displayed on a display device such as a touchscreen mounted in a housing of washer-dryer system 300. In another embodiment, user interface 380 is software running on a remote computer that communicates with control unit 370 and communications link 382 is a network connection that may be wired, wireless, or a combination.

Water filter 322 receives water from an external water source 324 and receives wash water through a connector 332 from wash/dry barrel 318. Water filtered by water filter 322 is stored in water tank 320. In one embodiment, water filter 322 uses activated carbon to filter impurities from the water.

Washer-dryer system 300 advantageously includes fuel cell tube 312 to provide both clean electricity to motor 314 and heat for wash and dry cycles of wash/dry barrel 318. Embodiments of washer-dryer system 300 can achieve energy efficiencies of about 60% or more. Although a fuel cell tube is shown in FIG. 3, other configurations of solid oxide fuel cells, including but not limited to a bundle of tubular SOFCs and a stack of planar SOFCs, and other types of fuel cells such as PEM fuel cells are within the scope of the invention.

In another embodiment, washer-dryer system 300 includes a second motor (not shown) that is powered by a fuel cell tube 312 to drive a second wash/dry barrel (not shown) that receives air and water from heat exchangers 316. In this embodiment, fuel cell tube 312 produces sufficient power to for concurrent operation of both motors.

The invention has been described above with reference to specific embodiments. It will, however, be evident that various modifications and changes may be made thereto without departing from the broader spirit and scope of the invention as set forth in the appended claims. The foregoing description and drawings are, accordingly, to be regarded in an illustrative rather than a restrictive sense.

What is claimed is:

1. A system comprising:
a fuel cell unit configured to generate electrical power and steam;
a motor configured to receive electrical power from the fuel cell unit;
a heat exchanger configured to receive steam from the fuel cell unit and configured to generate heated air and heated water;
a rotatable drum configured to receive at least one of the heated air and the heated water from the heat exchanger; and
a drive shaft coupled to the motor and the rotatable drum.

2. The system of claim 1, further comprising a control unit configured to control operation of the motor such that the motor causes the drive shaft and the rotatable drum to rotate at a predetermined rotational speed.

3. The system of claim 1, wherein the fuel cell unit comprises at least one solid oxide fuel cell tube.

4. The system of claim 1, wherein the fuel cell unit comprises at least one planar solid oxide fuel cell.

5. The system of claim 1, wherein the fuel cell unit comprise at least one proton exchange membrane fuel cell.

6. The system of claim 1, further comprising a reformer configured to reform a fuel into at least hydrogen gas for use by the fuel cell unit.

7. A dual mode fabric treatment apparatus comprising:
a fuel cell unit configured to generate electrical power and steam;
a motor configured to receive electrical power from the fuel cell unit;
a heat exchanger configured to receive steam from the fuel cell unit and configured to generate heated air and heated water;
a rotatable drum configured to receive the heated air from the heat exchanger during a dry cycle and to receive the heated water from the heat exchanger during a wash cycle; and
a drive shaft coupled to the motor and the rotatable drum.

8. The dual mode fabric treatment apparatus of claim 7, further comprising a control unit configured to control operation of the motor such that the motor causes the drive shaft and the rotatable drum to rotate at a predetermined rotational speed.

9. The dual mode fabric treatment apparatus of claim 7, wherein the fuel cell unit comprises at least one solid oxide fuel cell tube.

10. The dual mode fabric treatment apparatus of claim 7, wherein the fuel cell unit comprises at least one planar solid oxide fuel cell.

11. The dual mode fabric treatment apparatus of claim 7, wherein the fuel cell unit comprise at least one proton exchange membrane fuel cell.

12. The dual mode fabric treatment apparatus of claim 7, further comprising a reformer configured to reform a fuel into at least hydrogen gas for use by the fuel cell unit.
